(19) United States
(12) Patent Application Publication
(10) Pub. No.: US 2023/0345914 A1
(43) Pub. Date: Nov. 2, 2023

(54) EXTENDABLE-RETRACTABLE LEASH WITH PERSONAL PROTECTION AND ILLUMINATION

(71) Applicant: Brandon Orr, Burlington, KS (US)

(72) Inventor: Brandon Orr, Burlington, KS (US)

(21) Appl. No.: 18/142,338

(22) Filed: May 2, 2023

Related U.S. Application Data
(60) Provisional application No. 63/337,486, filed on May 2, 2022.

(51) Int. Cl. A01K 27/00; F21V 33/00; B26B 11/00

(52) U.S. Cl. CPC A01K 27/008; A01K 27/006; A01K 27/004; F21V 33/0004; B26B 11/008; H05C 1/00

(57) ABSTRACT

An extendable-retractable pet leash includes a housing with a spring-actuated take-up reel. A personal protection device is mounted on the housing and can comprise, for example, an extendable-retractable knife, a taser or a siren. The housing also mounts a light for illuminating a surrounding area. The leash, personal protection device and light can all be operated by actuators mounted on the housing for convenience, one-handed operation.

### CROSS-REFERENCE TO RELATED APPLICATION

This application claims priority in U.S. Provisional Patent Application No. 63/337,486, filed May 2, 2022, which is incorporated herein by reference.

### BACKGROUND OF THE INVENTION

### 1. Field of the Invention

The present invention relates generally to pet leashes featuring personal protection and a method for use thereof, and more specifically to extendable-retractable pet leashes featuring illuminating elements and a concealed personal protection device, which may consist of a knife or other bladed weapon.

### 2. Description of the Related Art

Personal protection and self-defense are primary concerns for many individuals. For example, dog owners routinely attach leashes to maintain their dogs in close proximity and for guidance along dog-walking routes.

However, dog walkers are vulnerable to attack, particularly since they are preoccupied with handling leashes and distracted by their dogs' activities. Muggers, purse-snatchers and other assailants may take advantage of such vulnerabilities

The present invention provides a solution by combining a leash with an extendable-retractable knife. Heretofore there has not been available a self-defense system with the advantages and features of the present invention.

### SUMMARY OF THE INVENTION

The present invention generally provides a leash handle with an extendable-retractable knife, which can be deployed without releasing the leash. The deployed knife can be utilized for stabbing an assailant without releasing the leash. Thus, security for both the pet and the pet owner is enhanced. The handle can be equipped with additional features for convenience and protection. For example, flashlights, audible alarms and disabling sprays (e.g., mace) components can be mounted on the leash handle.

### BRIEF DESCRIPTION OF THE DRAWINGS

The drawings constitute a part of this specification and include exemplary embodiments of the present invention illustrating various objects and features thereof.

FIG. 1 is a side elevational view of an extendable-retractable leash with personal protection and illumination, embodying an aspect of the present invention.

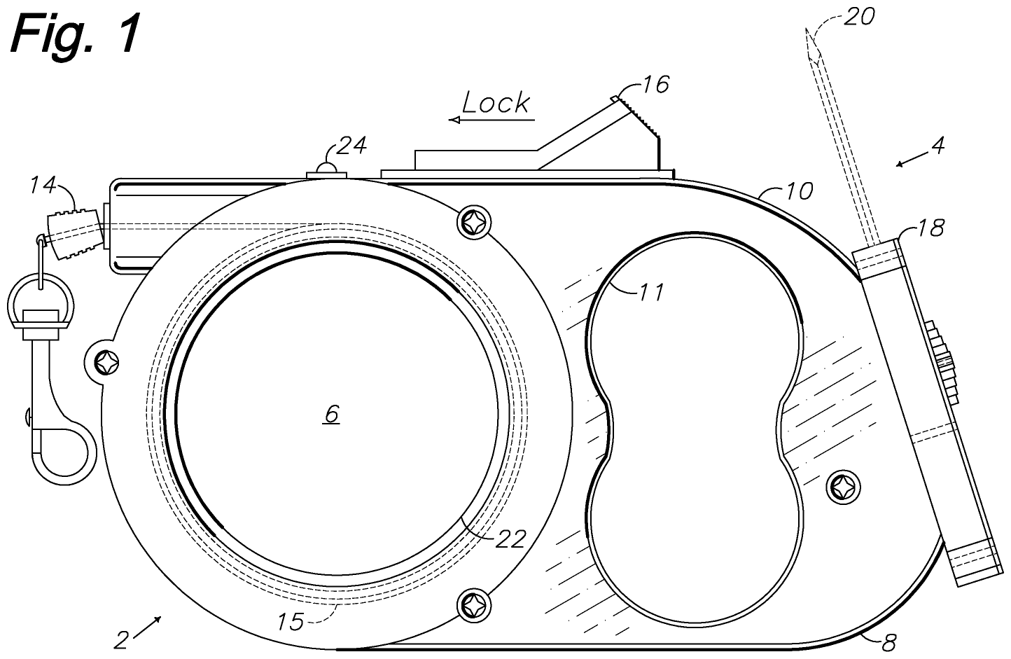

FIG. 2 is another elevational view thereof.

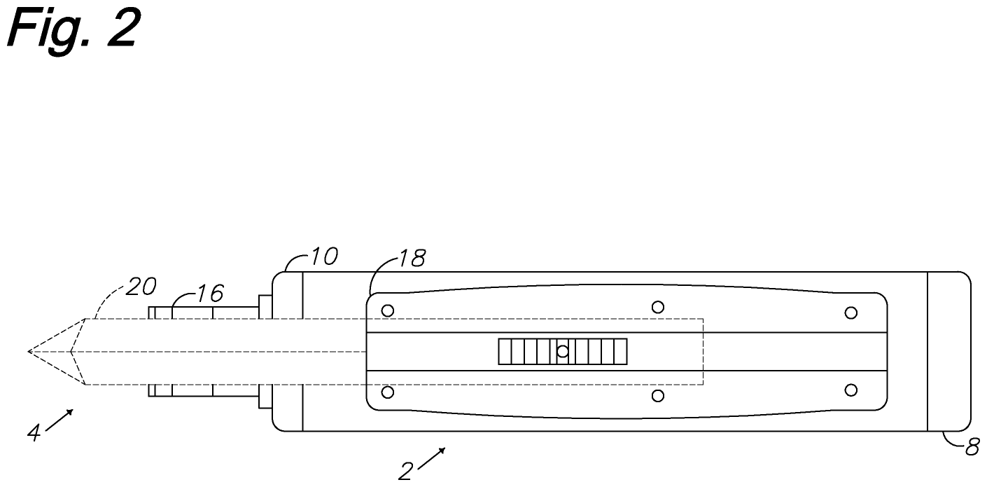

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Extendable-Retractable Leashes with Personal Protection and Illumination 2

The reference numeral 2 generally designates an extendable-retractable leash with a personal protection device 4 and an illumination device 6, embodying an aspect or embodiment of the present invention. Without limitation, the personal protection can comprise a knife 4. The illumination device 6 can include an external, side-mounted light lens.

The leash 2 includes a housing 8 with a proximal portion configured as a handle 10 and a distal portion 11. A leash 14 extends from the handle 10 and encloses a leash take-up reel 15 actuated by a slide actuator 16 mounted on the housing 8 in proximity to a handle opening 10.

Without limitation on the generality of suitable personal protection devices, a knife 18 with an extendable-retractable blade 20 is shown. Alternatively, other personal protection devices, such as a taser, alarm, etc. can be provided. The housing 8 can also mount a light actuator switch 24.

### III. Operation

In operation, the leash 14 can be attached to a pet collar for keeping the pet in close proximity. For example, a user taking his or her dog for a walk can control the separation distance with the leash 14 and the slide actuator 16. In some circumstances, the user may prefer maintaining the dog in close proximity corresponding to a relatively short length of the leash 14 extended from the housing 8. In other circumstances, the dog may be permitted to stray further by extending the leash 14. The take-up reel 15 can be configured for retracting and locking via the slide actuator 16.

If a threatening situation is encountered, e.g., involving an assailant or another animal, the knife 4 can be deployed to fend off an assailant or assailants. Additional security is provided by the light 6, which can illuminate the surrounding area.

The extendable-retractable leash 2 enables one-handed operation of the slide actuator 16, deployment of the knife 18 and switching the light 6 on and off. A dog-walker can thus use his or her free hand, for example, to place an emergency call with a mobile communications device. The extendable-retractable leash 2 also enhances animal security by providing protection for fending off an assailant and illuminating the surrounding area.

It is to be understood that the invention can be embodied in various forms and is not to be limited to the examples specifically discussed above. The range of components and configurations which can be utilized in the practice of the present invention is virtually unlimited.

Having thus described the invention, what is claimed as new and desired to be secured by Letters Patent is:

1. An extendable-retractable pet leash with a personal protection device, which leash comprises:
a housing configured for receiving a leash and including a handle opening;
a personal protection device mounted on said housing in proximity to said handle opening;
said personal protection device including an actuator; and
an illumination device mounted on said housing.

2. The extendable-retractable pet leash according to claim 1, which includes:
said personal protection device comprising a knife.

3. The extendable-retractable pet leash according to claim 1, which includes:
said personal protection device comprising a taser.

4. The extendable-retractable pet leash according to claim 1, which includes:
said personal protection device comprising a siren.

5. The extendable-retractable pet leash according to claim 1, which includes a leash take-up reel mounted within said housing.

6. The extendable-retractable pet leash according to claim 5, which includes a slide actuator mounted on said housing and configured for controlling the extension and retraction of said leash.
